(19) United States
(12) Patent Application Publication
(10) Pub. No.: US 2016/0146042 A1
(43) Pub. Date: May 26, 2016

(54) GAS TURBINE AND HEAT SHIELD FOR A GAS TURBINE

(71) Applicant: SIEMENS AKTIENGESELLSCHAFT, München (DE)

(72) Inventors: Fathi Ahmad, Kaarst (DE); Ursula Pickert, Mulheim an der Ruhr (DE)

(73) Assignee: Siemens Aktiengesellschaft, Munich (DE)

(21) Appl. No.: 14/900,166

(22) PCT Filed: Jun. 25, 2014
(86) PCT No.: PCT/EP2014/063426

§ 371 Date: Dec. 20, 2015

(30) Foreign Application Priority Data
Jun. 28, 2013 (DE) 10 2013 212 741.3

(51) Int. Cl. F01D 25/08; F01D 9/06; F01D 11/12; F01D 5/06; F01D 9/04

(52) U.S. Cl. CPC F01D 25/08; F01D 5/06; F01D 9/041; F01D 11/122; F01D 9/06; F05D 2220/32; F05D 2240/12; F05D 2240/15; F05D 2240/24; F05D 2260/231; F05D 2300/20; F05D 2300/502; F05D 2300/516; F05D 2300/611

(57) ABSTRACT

A gas turbine includes a number of annular rotor blade rows coaxially mounted in a heating gas channel and a number of annular stator blade rows mounted between the rotor blade rows, wherein at least between two immediately adjacent stator blade rows a heat shield is positioned, which circumferentially surrounds the rotor blade row positioned between the two adjacent stator blade rows, and which has multiple ring segments, wherein at least one of the ring segments has an abrasion coating and at least one of the ring segments has no abrasion coating.

### CROSS REFERENCE TO RELATED APPLICATIONS

This application is the US National Stage of International Application No. PCT/EP2014/063426 filed Jun. 25, 2014, and claims the benefit thereof. The International Application claims the benefit of German Application No. DE 102013212741.3 filed Jun. 28, 2013. All of the applications are incorporated by reference herein in their entirety.

### FIELD OF INVENTION

The invention relates to a gas turbine comprising a number of ring-shaped rotor blade rows arranged coaxially in a hot-gas duct and a number of ring-shaped guide blade rows arranged between the rotor blade rows, and to a heat shield for a corresponding gas turbine.

### BACKGROUND OF INVENTION

Gas turbines are used in many sectors for driving working machines, such as for example generators. Gas turbines are combustion engines in which a part of the energy stored in a fuel is utilized to generate a rotational movement of a turbine shaft. For this purpose, the fuel is mixed with air compressed in an air compressor and is burned in a combustion chamber. The hot gas which is generated in the combustion chamber as a result of the combustion of the fuel-air mixture and which is at high pressure is subsequently conducted into a hollow cylindrical or hollow conical hot-gas duct, which is connected downstream of the combustion chamber, of the turbine unit, where said hot gas finally expands, performing work.

Here, for the generation of the rotational movement of the turbine shaft, a number of rotor blades, normally combined to form ring-shaped or annular rotor blade rows, are arranged on said turbine shaft, which rotor blades drive the turbine shaft by way of transfer of impetus from the hot gas. For advantageous flow guidance of the hot gas, it is furthermore normally the case that guide blades, combined to form ring-shaped or annular guide blade rows and connected to the turbine housing, are arranged between adjacent rotor blade rows. Said guide blades are normally fastened to hollow cylindrical or hollow conical guide blade supports.

In designing such gas turbines, consideration is generally given not only to the achievable power but also to the highest possible efficiency. An increase in efficiency can in this case be achieved for example by increasing the outlet temperature at which the hot gas flows out of the combustion chamber and into the turbine unit. Here, at present, temperatures of approximately 1200° C. to 1500° C. are sought, and also achieved, for corresponding gas turbines.

At such high temperatures of the hot gas, however, the components and parts exposed to said hot gas are subject to high thermal loads. Therefore, the hot-gas duct is normally lined with so-called ring segments which protect the inner wall of the hot-gas duct against thermal overloading and thus act as a heat shield. Said ring segments are commonly fastened by way of hook elements, wherein, in the circumferential direction, the ring segments, like the guide blade support, form a hollow conical or hollow cylindrical structure.

Here, the parts of the gas turbine may deform owing to different thermal expansion in different operating states, which has a direct influence on the size of the radial gaps between the rotor blades and the inner wall of the hot-gas duct. Here, the size of the radial gaps varies during the start-up and run-down of the gas turbine, and assumes different values in these operating states than during normal operation. In the construction of the gas turbine, it is necessary for all components to be dimensioned such that the radial gaps are, regardless of the operating state, large enough that no damage is to be expected during the operation of the gas turbine. An oversized configuration of the radial gap however leads to considerable losses in efficiency of the gas turbine.

For example, it is known from EP 1 925 512 A1 for not a closed ring but an open ring to be arranged, as a flow-delimiting means, opposite the tips of the rotor blades. A spring or else a hydraulically or pneumatically actuated lifting mechanism should be arranged in the ring-shaped gap in order to enable the diameter of the ring to be adapted to the desired size in automatic or controlled fashion. Owing to the open form of the ring, however, leakage of working medium, and possibly special sealing concepts, are necessary, for which reason said solution is considered to be disadvantageous.

### SUMMARY OF INVENTION

Taking this as a starting point, it is an object of the invention to specify an advantageously configured gas turbine and a heat shield for a corresponding gas turbine.

This object is achieved according to the invention by way of a gas turbine having the features of the independent claim. The back-referenced claims contain, in part, advantageous and, in part, independently inventive refinements of this invention.

Here, the gas turbine comprises a number of ring-shaped rotor blade rows arranged coaxially in a hot-gas duct and a number of ring-shaped guide blade rows arranged between the rotor blade rows, wherein, at least between two immediately adjacent guide blade rows, there is positioned a heat shield which circumferentially surrounds the rotor blade row positioned between said two adjacent guide blade rows and which has multiple ring segments, of which at least one is coated with an abrasion coating. Here, the ring segments expediently serve for lining that section of the hot-gas duct which is situated between said two adjacent guide blade rows, and for this purpose, the ring segments are mounted on a wall of said section, for example by way of hook elements. The ring segments thus together form a ring-shaped assembly, wherein the assembly is typically of hollow conical or hollow cylindrical form depending on the geometry of the hot-gas duct.

Here, the heat shield however serves not only for protecting components and parts situated therebehind against thermal overloading, but also for resolving the conflict, mentioned in the introduction, in the configuration of the size of the radial gaps. Here, the radial gaps are, during the course of the construction, configured so as to be tendentially too small, as a result of which, in certain operating states, contact can occur between the tips of rotor blades and the inner wall of the hot-gas duct. It is however specifically in this region of the inner wall of the hot-gas duct that the heat shield composed of the ring segments is positioned, and at least one of said ring segments is provided with an abrasion coating. Said abrasion coating is designed to be relatively soft, such that, in the event of contact with the tip of a rotor blade, damage to the rotor blade is ruled out, and only gradual removal of the abrasion coating is to be expected. The abrasion coating thus functions as a type of sacrificial layer which is gradually worn away during the operation of the gas turbine. In this way, it is firstly possible for the radial gaps to be designed to be very small, which benefits the efficiency of the gas turbine, and secondly, the risk of damage during the operation of the gas turbine owing to the contact of the rotor blades with the inner wall of the hot-gas duct can be kept low.

Here, the ring segments are furthermore advantageously designed as wearing parts, and are accordingly exchanged at certain time intervals during the course of maintenance work. As a result, the ring segments with abrasion coating are then also exchanged at certain time intervals, such that the expected gradual wear of the abrasion coating can be compensated in this way.

In principle, it would now be possible for the gas turbine to be designed such that a heat shield composed of ring segments is positioned in the region of each rotor blade row, and such that, furthermore, each of the ring segments is coated with an abrasion coating. However, it has been identified that, depending on the design of the gas turbine, it suffices for a corresponding heat shield to be positioned in the region of that rotor blade row which is situated closest to the combustion chamber of the gas turbine, because it is here that the highest thermal load exists and that the greatest fluctuations in the values of the radial gaps are to be expected. Accordingly, a design variant of the gas turbine is advantageous in which either no heat shield, or at least no heat shield with a ring segment with abrasion coating, is positioned in the region of that rotor blade row or in the regions of those rotor blade rows which is or are situated furthest remote from the combustion chamber.

It has furthermore been identified that, if an embodiment of the heat shield is used in which all of the ring segments have an abrasion coating, the wear of the abrasion coating during the operation of the gas turbine does not take place uniformly in all ring segments. Rather, virtually no wear occurs in some ring segments, whereas significant wear occurs in individual ring segments. For this reason, an embodiment of the gas turbine is advantageous in which at least one of the ring segments has an abrasion coating and at least one of the ring segments of the same heat shield does not have an abrasion coating. Accordingly, an abrasion coating is used only where it is actually needed, and a corresponding abrasion coating is omitted in the case of the other ring segments. Since the production of ring segments with a corresponding abrasion coating is associated with higher costs than the production of ring segments without a corresponding abrasion coating, it is possible in this way to achieve considerable cost savings, wherein this has an effect not only on the procurement costs but also on the ongoing operating costs, because as mentioned before, the ring segments are typically formed as wearing parts, and are accordingly repeatedly exchanged at certain time intervals.

In deciding which of the ring segments of a heat shield should be coated with an abrasion coating and for which of the heat shields this can be dispensed with, use may be made not only of calculations but furthermore also of obtained empirical values. In particular if it is sought to manufacture a new model series or a new model generation, it is provided that, in a first operational phase, initially all of the ring segments of the heat shield are coated with an abrasion coating in order to reliably prevent damage to the gas turbine. After a first exchange of the ring segments during the course of maintenance work, it is then possible to identify, by examining the ring segments, which ring segments of the heat shield should actually be coated with an abrasion coating, and whether the calculations in this regard are accurate.

Here, an embodiment of the gas turbine has proven to be expedient in which more than 10% and less than 50% of the ring segments of a heat shield have an abrasion coating.

Here, for the abrasion coating, use may be made of a heat-resistant ceramic material which has approximately the strength or consistency of blackboard chalk. In this way, during the wearing process, a fine powder is produced as abrasion, which is easily transported away, and discharged to the outside, together with the hot gas. An accumulation of the abraded material in the hot-gas duct, and accordingly fouling of the rotor blades or guide blades, is thus prevented.

Also advantageous is an embodiment of the gas turbine in which all of the ring segments have a thermal coating which is applied to a main body. The main body can then be manufactured from a simpler, less temperature-resistant material, with only the thermal coating, which comes into direct contact with the hot gas, being produced from a high-grade material which can be subjected to particularly high thermal loading. In this way, too, the production costs for the ring segments can be reduced, and it is furthermore possible, in principle, for the main bodies of the ring segments to be reused, and for only the thermal coating to be renewed. This variant is also advantageous from an ecological aspect. If a corresponding thermal coating is provided for the ring segments, the abrasion coating, if provided, is expediently applied to the thermal coating.

For the effectiveness of a gas turbine, what are essential are firstly very small values for the radial gaps between the rotor blade tips and the inner wall of the hot-gas duct, and secondly the best possible flow characteristic in the hot-gas duct. For this reason, in the case of a gas turbine proposed here, it is advantageous for all of the ring segments of a heat shield to have the same thickness, that is to say the same extent in a radial direction in relation to the cylinder symmetry of the turbine unit of the gas turbine. Accordingly, in specifying the dimensions for the ring segments and the components thereof, it must be taken into consideration which of the ring segments is provided with an abrasion coating, and which of the ring segments are not. In the case of the ring segments being formed with a thermal coating, a uniform thickness for all of the ring segments is advantageously realized by virtue of the thermal coating having a greater thickness or layer thickness in the case of the ring segments without abrasion coating than in the case of the ring segments with abrasion coating. In this way, the main body of all of the ring segments can be formed with the same dimensions, and the prerequisite of a uniform thickness for all of the ring segments is satisfied by way of different layer thicknesses of the thermal coating. Here, it is pointed out that typical thermal coatings generally entail substantially lower manufacturing costs than suitable abrasion coatings.

### BRIEF DESCRIPTION OF THE DRAWINGS

Exemplary embodiments of the invention will be discussed in more detail below on the basis of a schematic drawing, in which:

FIG. 1 shows a gas turbine with a heat shield in a two-part illustration composed of longitudinal section and side view, and

FIG. 2 shows the heat shield in a cross-sectional illustration.

### DETAILED DESCRIPTION OF INVENTION

Parts which correspond to one another are each denoted by the same reference signs in all of the figures.

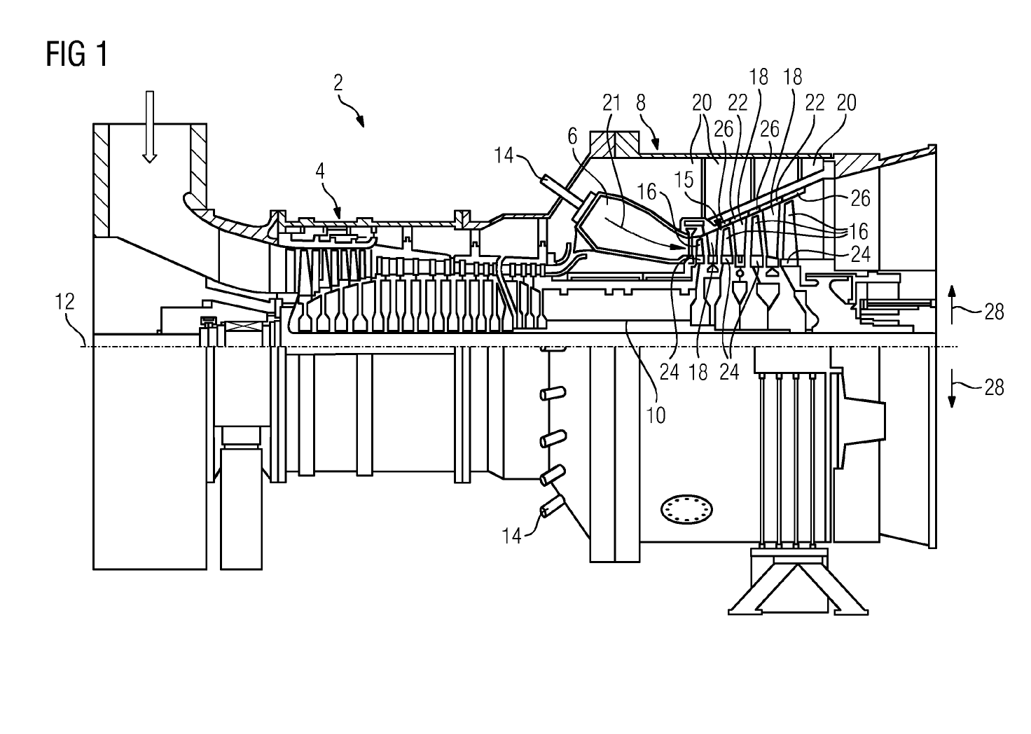

A gas turbine 2 described by way of example below is depicted in FIG. 1 and, in a manner known per se, has a compressor 4, a combustion chamber 6 and a turbine unit 8.

The combustion chamber 6, which is formed in the manner of a ring-shaped combustion chamber, is in this case equipped with a number of burners 14 for the combustion of a liquid or gaseous fuel, and opens into a hot-gas duct 15 of the turbine unit 8.

The turbine unit 8 and the compressor 4 are furthermore arranged on a common turbine shaft 10, also referred to as turbine rotor, to which a work machine (not illustrated) is also connected in non-positively locking fashion and which is mounted so as to be rotatable about a turbine axis 12. Furthermore, the turbine unit 8 has a number of rotor blades 16 which are arranged in the hot-gas duct 15 and which are connected to the turbine shaft 10 and which are rotatably mounted by way of said turbine shaft. Here, the rotor blades 16 are arranged in ring-shaped or annular form on the turbine shaft 10, wherein each ring of rotor blades 16 forms a rotor blade row. Furthermore, the turbine unit 8 comprises a number of static guide blades 18, which in turn form ring-shaped or annular guide blade rows and are each fastened to a guide blade support 20 of the turbine unit 8.

Here, the rotor blades 16 serve for the drive of the turbine shaft 10 by way of a transfer of impetus from a hot gas which is generated as a result of the combustion of the fuel, or rather of a fuel-air mixture, in the combustion chamber 6 and which is conducted through the hot-gas duct 15 of the turbine unit 8. By contrast, the guide blades 18 serve for guiding the flow of the hot gas in the hot-gas duct 15 into the intermediate regions between in each case two guide blade rows positioned in succession as viewed in the flow direction 21 of the hot gas. A pair composed of a guide blade row and a rotor blade row positioned in succession is in this case also referred to as a turbine stage.

Each guide blade 18 furthermore has a guide blade root 22 which serves for the fixing of the respective guide blade 18 to a guide blade support 20 of the turbine unit 8, and which furthermore serves as a wall or wall element of the hot-gas duct 15. Accordingly, like the guide blade 18, the guide blade root 22 is a thermally relatively highly loaded component which forms the outer delimitation of the hot-gas duct 15 for the hot gas flowing through the turbine unit 8. Each rotor blade 16 is analogously fastened to the turbine shaft 10 by way of a rotor blade root 24.

Between the guide blade roots 22, which are arranged spaced apart from one another as viewed in the flow direction 21 of the hot gas, of two adjacent guide blade rows, there are now arranged in each case ring segments 26 which are detachably mounted on a guide blade support 20 of the turbine unit 8. That surface of each ring segment 26 which faces toward the hot-gas duct 15 is in this case likewise exposed to the hot gas and is thus subjected to relatively high thermal load.

Here, the ring segments 26 which are assigned to a turbine stage and thus to a rotor blade row form a ring-shaped heat shield 30, by means of which the inner wall of the hot-gas duct 15 is lined in the region of the rotor blade row and thus in the intermediate region between two guide blade rows. Said heat shield 30 protects the components and parts situated behind it against thermal overloading, and is in the form of a wearing part which is exchanged at certain time intervals during the course of maintenance work.

In the case of the gas turbine 2 described here by way of example, a heat shield 30 is provided for each turbine stage and is accordingly mounted on the associated guide blade support 20. Here, however, the heat shields 30 are not of identical form, but rather are designed to exhibit different levels of heat resistance inter alia owing to the different intensities of thermal load expected in the corresponding regions in which the heat shields 30 are positioned. Furthermore, the heat shields 30 are constructed from different numbers and/or different sizes of ring segments 26 owing to the conical geometry of the hot-gas duct 15.

A corresponding ring segment 26 however has, in principle, a main body 32 which is lined with a thermal coating 34 in the region of the surface which faces toward the hot-gas duct 15. To realize adapted heat resistance, it is now the case that the ring segments 26 of the various heat shields 30 for the various turbine stages have thermal coatings 34 of different layer thickness. That is to say, the ring segments 26 of that heat shield 30 which is situated closest to the combustion chamber 14 have the greatest layer thickness, whereas the ring segments 26 of that heat shield 30 which is positioned furthest remote from the combustion chamber 6 have the smallest layer thickness.

Between the rotor blades 16 of a rotor blade row and the ring segments 26 of the heat shield 30 which circumferentially surrounds the rotor blade row, there is provided a radial gap which permits a free rotation of the rotor blades 16. The value of said radial gap, that is to say the extent in the radial direction 28, is in this case dimensioned to be very small in order to reduce the flow of hot gas through the radial gap to a minimum. Furthermore, the value of the radial gap varies in a manner dependent on the operating state of the gas turbine 2 owing to thermal expansion, which furthermore takes place to different extents in the various components. As a result, in some operating states of the gas turbine 2, the tips of the rotor blades 16 of the first turbine stage, that is to say of the rotor blade row which is situated closest to the combustion chamber 6, come into contact with the heat shield 30 which is assigned to said turbine stage and which is mounted on the corresponding guide blade support 20.

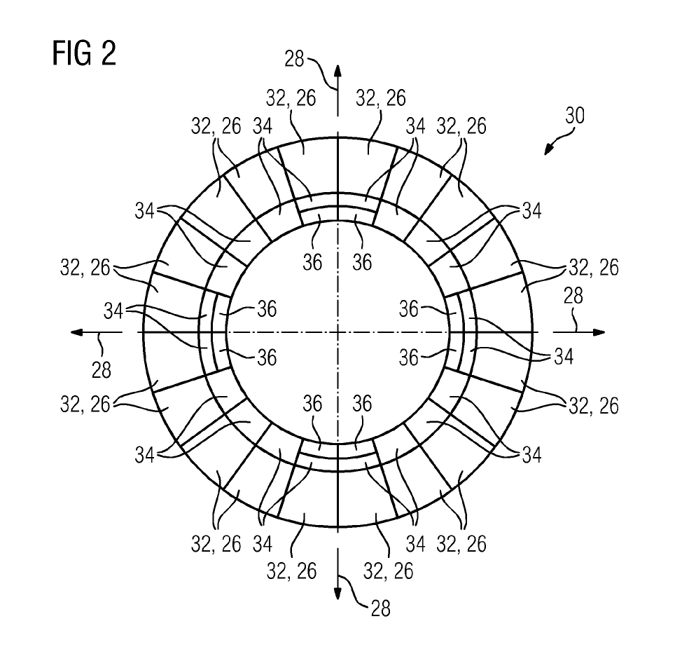

Corresponding points of contact between the tips of the rotor blades 16 and the heat shield 30 however do not arise in the case of all of the ring segments 26 of said heat shield 30, but rather only in the case of ring segments 26 which are arranged in four regions in relation to the circumference of the heat shield 30. FIG. 2 is a diagrammatic depiction of the heat shield 30 in question in a cross-sectional illustration, wherein the proportions of the dimensions are not representative. The regions in which the points of contact between the rotor blades 16 and the heat shield 30 arise are, in this figure, situated at the top (12 o'clock), at the bottom (6 o'clock), at the left (9 o'clock) and at the right (3 o'clock). In these regions, the ring segments 26 have not only a thermal coating 34, which is applied to a main body 32, but also an abrasion coating 36, which is applied over the thermal coating 34. Said abrasion coating 36 is of relatively soft consistency, such that contact with said abrasion coating 36 does not lead to damage to the corresponding rotor blade 16, but merely to damage of the abrasion coating 36. Accordingly, the abrasion coatings 36 of the ring segments 26 of said heat shield 30 are gradually removed during the operation of the gas turbine 2, which is however not a problem because the ring segments 26 of the heat shield 30 must indeed be exchanged at certain time intervals during the course of maintenance work in any case.

In order that the additional coating of individual ring segments 26, that is to say the abrasion coatings 36, do not adversely affect the flow characteristic and permit different values for the radial gap, all of the ring segments 26 of the heat shield 30 have the same thickness, that is to say the same extent in a radial direction 28. To realize this uniform thickness, the thermal coating 34 of those ring segments 26 which do not have an abrasion coating 36 is designed to be thicker, specifically precisely by the layer thickness size that corresponds to the layer thickness of the abrasion coating 36.

In the exemplary embodiment, precisely eight ring segments 26 of the heat shield 30 of the first turbine stage have an abrasion coating 36, and all of the other ring segments 26 of said heat shield, and all of the other ring segments 26 of the other heat shields 30, do not have an abrasion coating 36. The number of ring segments 26 with abrasion coating 36 is in this case dependent on the respective design of the gas turbine 2, and may accordingly vary.

The invention is not restricted to the exemplary embodiment described above. Rather, it is also possible for other variants of the invention to be derived by a person skilled in the art without departing from the subject matter of the invention. In particular, all of the individual features described in conjunction with the exemplary embodiment may also be combined with one another in other ways without departing from the subject matter of the invention.

1.-8. (canceled)

9. A gas turbine, comprising:
a number of ring-shaped rotor blade rows arranged coaxially in a hot-gas duct,
a number of ring-shaped guide blade rows arranged between the rotor blade rows, and
a heat shield positioned, at least between two immediately adjacent guide blade rows, which circumferentially surrounds the rotor blade row positioned between said two adjacent guide blade rows and which has multiple ring segments,
wherein at least one of the ring segments has an abrasion coating and at least one of the ring segments does not have an abrasion coating.

10. The gas turbine as claimed in claim 9,
wherein more than 10% and less than 50% of the ring segments has an abrasion coating.

11. The gas turbine as claimed in claim 9,
wherein the abrasion coating is composed of a ceramic material.

12. The gas turbine as claimed in claim 9,
wherein all of the ring segments have a thermal coating.

13. The gas turbine as claimed in claim 9,
wherein, in the case of the ring segments which have an abrasion coating, the abrasion coating is applied over a thermal coating.

14. The gas turbine as claimed in claim 9,
wherein all of the ring segments have the same thickness.

15. The gas turbine as claimed in claim 12,
wherein, to realize a uniform thickness for all ring segments, the thermal coating has a greater thickness in the case of the ring segments without abrasion coating than in the case of the ring segments with abrasion coating.

16. A hollow cylindrical or hollow conical heat shield for a hot-gas duct of a gas turbine, comprising
multiple ring segments,
wherein, for the purposes of lining, a section of the hot-gas duct, is installed on a wall of the hot-gas duct,
wherein, in a fully installed state, collectively the multiple ring segments form a ring-shaped assembly, and
wherein at least one of the ring segments has an abrasion coating and at least one of the ring segments does not have an abrasion coating.
